(19) United States
(12) Patent Application Publication
(10) Pub. No.: US 2013/0326933 A1
(43) Pub. Date: Dec. 12, 2013

(54) FLY EXTERMINATING APPARATUS

(71) Applicant: MYONG CHOL JUNG, GYEONGGI-DO (KR)

(72) Inventor: MYONG CHOL JUNG, GYEONGGI-DO (KR)

(21) Appl. No.: 13/907,959

(22) Filed: Jun. 2, 2013

(30) Foreign Application Priority Data
Jun. 12, 2012 (KR) 10-2012-0062449

(51) Int. Cl. A01M 5/04; A01M 5/08

(52) U.S. Cl. CPC A01M 5/04; A01M 5/08
USPC 43/140

(57) ABSTRACT

Provided is a fly exterminating apparatus where flies are attracted to a main body that is movable in an orbital-to-spin method and then are suctioned and captured by a vacuum negative pressure. Also, a shock generation part that generates an electrical shock due to current by being associated with the moving main body when contacting the flies is provided to exterminate the flies; a reflective plate that discombobulates the flies to make away with the flies is disposed to exterminate the flies through various methods. The fly exterminating apparatus includes a main body on which a caterpillar that orbitally rotates and wheels are disposed on a lower portion thereof to move in an orbital-to-spin method, an attracting unit mounted on the main body to attract flies, and a capture unit connected to the attracting unit to suction the flies attracted by the attracting unit by using a vacuum negative pressure.

### CROSS-REFERENCE TO RELATED APPLICATION

This application claims priority to Korean Patent Application No. 10-2012-0062449 filed on Jun. 12, 2012 and all the benefits accruing therefrom under 35 U.S.C. §119, the contents of which are incorporated by reference in their entirety.

### BACKGROUND

The present invention relates to a fly exterminating apparatus, and more particularly, to a robot-type fly exterminating apparatus having an improved structure in which an attraction unit for attracting flies and a capture unit for capturing the attracted flies by using a vacuum negative pressure are disposed on a movable main body using a caterpillar to easily exterminate the flies without using fly attractant, and also, to easily exterminate the flies by using a shock generation part and a reflective plate.

In general, flies that are a kind of insects are noxious pests because the flies act as media of pathogens, transport the pathogens, and induce causes of myiasises.

Particularly, since household flies live together with persons in the house, the household flies may spread pathogens such as typhoid, cholera, amoebic dysentery, bacillary dysentery, and the like through their hairs or legs. In addition, since household files have a habit of throwing up one's food together with the pathogens, the household flies may directly spread the pathogens.

Furthermore, with the development of means of transportation, flies may be easily carried together with airplanes or ships everywhere in the whole world to intensify the spreading of the pathogens. Livestock-friendly flies may be classified into stock farm type flies and livestock barn type flies. The livestock-friendly flies may be grown in livestock excretions to suck blood of livestock. Thus, the flies may carry diseases such as myiasises into the livestock or carry bacterially caused diseases into crops to significantly damage the livestock or crops. In addition, the flies may spread plant louses to crops through their bodies or legs to damage the crops.

Thus, flies that are insects doing more harm than good should be exterminated because the flies set up unsanitary environments at households, particularly, farms, livestock barns, restaurants, amusement parks, or the like and cause transmittable diseases.

Due to above-described reasons, flypapers or chemicals such as aerosol containing insecticide components are being used in households. However, the flypapers and chemicals may have limitations in hygienic aspects and do harm to child's health due to the chemical spraying.

Also, a fly exterminating method using a chemical is being widely performed in farms or livestock barns. Although the fly exterminating method using the chemical effectively exterminates flies at once, there is a trouble in which the chemical should be frequently sprayed. Also, livestock may be damaged by the chemical, and a new chemical having high pesticidic performance should be continuously required because the flies develop a tolerance to the chemical due to the use of the chemical for a long time.

On the other hand, there is a fly trap that attracts flies to commit the body to the deep without using chemicals. However, there is a trouble in which the favorite foods of the flies should be replaced after a predetermined time elapses because the foods are disposed within a cover body of a dome. In addition, disgust may be induced, and unsanitary environments may set up due to the flies that are buried at water.

Also, a fly inducing exterminator in which a heater, a shock part in which current flows, and a favorite attracting agent for flies are disposed within a sealed case to attract flies by using the attracting agent and kill the flies by using the shock part. However, the fly inducing exterminator may be complicated in structure. In addition, since the attracting agent is disposed within the fly inducing exterminator, the attracting agent should be replaced after a predetermined time elapses to prevent bad small from occurring due to the spoil of decay of the attracting agent.

Also, since the above-described existing fly exterminators are fixedly installed, the fly exterminators do not response to movement of mobile flies.

### SUMMARY

The present invention provides a movable fly exterminating apparatus having an improved structure which is capable of attracting and capturing flies without applying an attracting agent.

The present invention also provides a fly exterminating apparatus having an improved structure in which a shock part through which current flows is disposed in a movable main body to exterminate flies without attracting the flies.

The present invention also provides a fly exterminating apparatus having an improved structure in which flies are suctioned and captured by using a vacuum negative pressure after attracting the flies by using light to attract and capture the flies without using chemicals such as attracting agents.

In accordance with an exemplary embodiment of the present invention, a fly exterminating apparatus includes: a main body movable by a caterpillar that is orbitally rotates; an attracting unit mounted on the main body to attract flies; and a capture unit connected to the attracting unit to suction the flies attracted by the attracting unit through a vacuum negative pressure, thereby capturing the flies.

The attracting unit may include: an attracting part having a hopper shape with a diameter gradually increasing toward an upper portion thereof; and a light emitting body disposed on an inner circumferential surface of an inlet side of the attracting part to emit light for attracting the flies by applying an external power source thereto.

The capture unit may include: a suction hose having one end connected to the attracting unit; a capture container to which the other end of the suction hose is connected, the capture container having an opened upper portion; a cap member openably coupled to the upper portion of the capture container, the cap member having a plurality of punched suction holes in an upper portion thereof; and a suction fan connected to the upper portion of the cap member to form the vacuum negative pressure within the capture container through the suction holes.

The fly exterminating apparatus may further include a shock generation part, through which current flows to generate electrical shock when the shock generation part contacts the flies, on a front surface of the main body.

The fly exterminating apparatus may further include reflective plates stacked and mounted on an upper portion of the main body, the reflective plates each having a back surface by which surrounding images and light are reflected; and a reflective plate take-out part for discharging the reflective plates one by one to the outside when the main body moves.

### BRIEF DESCRIPTION OF THE DRAWINGS

Exemplary embodiments can be understood in more detail from the following description taken in conjunction with the accompanying drawings, in which:

FIG. 1 is a perspective view of a fly exterminating apparatus according to the present invention;

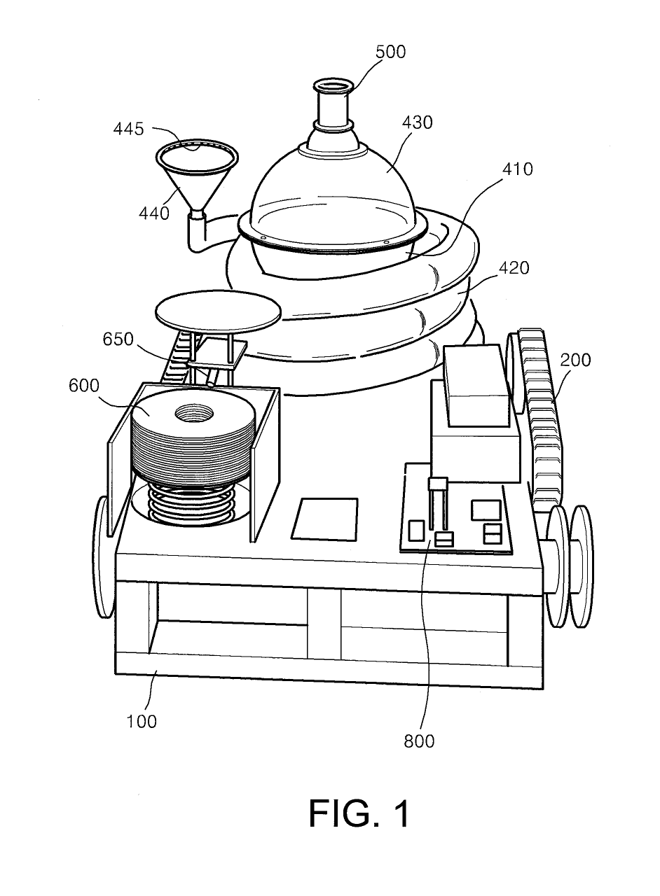

FIG. 2 is a perspective view of a main body and a caterpillar according to the present invention;

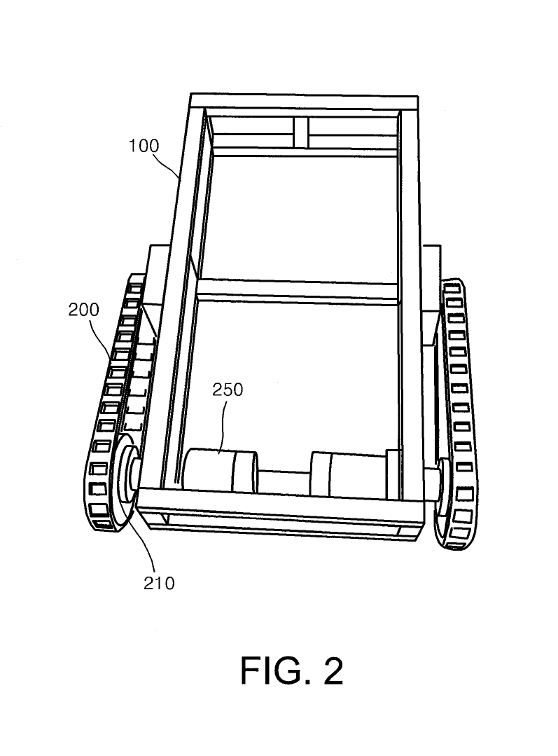

FIG. 3 is a perspective view of an attraction unit and a capture unit according to the present invention;

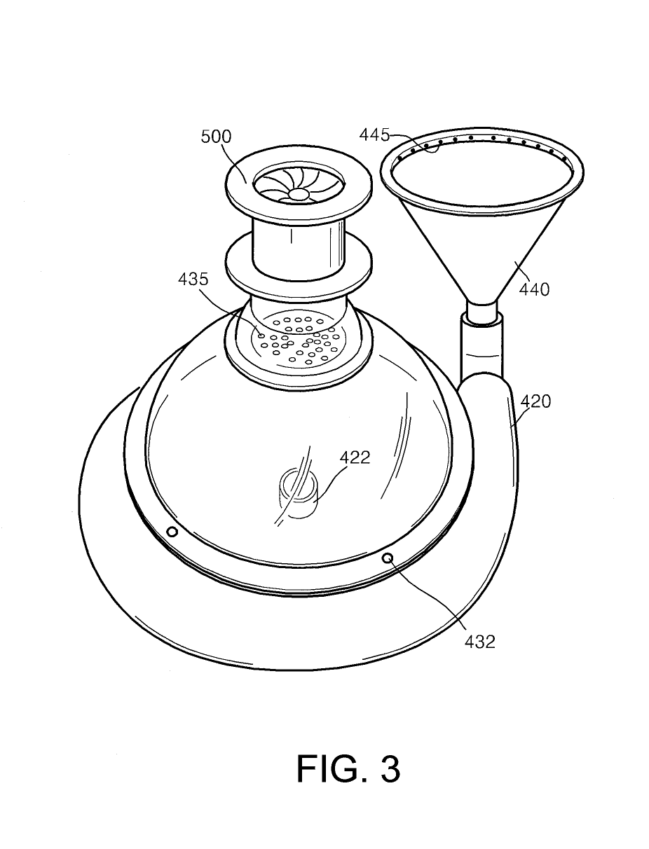

FIG. 4 is a perspective view illustrating a front portion of the fly exterminating apparatus according to the present invention; and

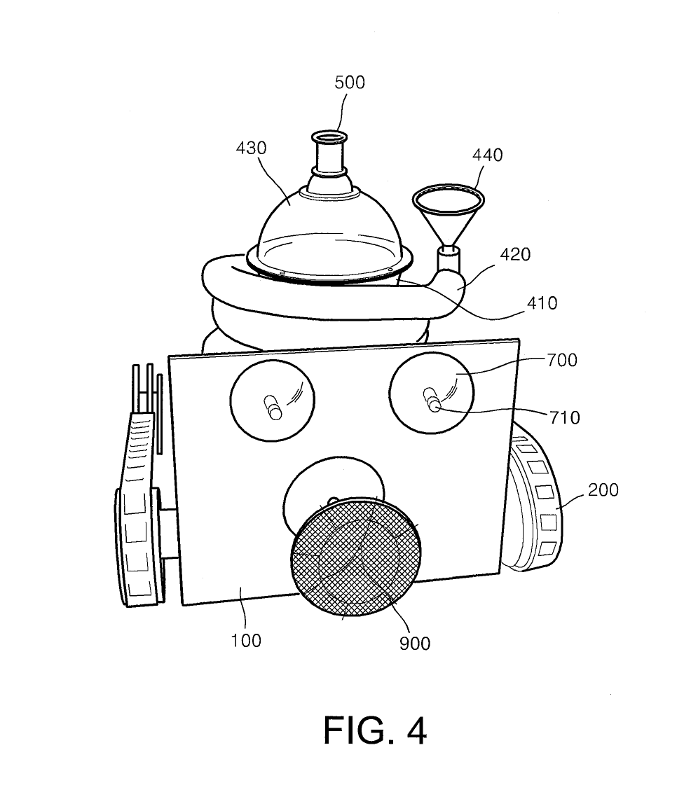

FIG. 5 is schematic view illustrating an operation process of a reflective plate take-out part according to the present invention.

### DETAILED DESCRIPTION OF EMBODIMENTS

In a fly exterminating apparatus according to the present invention, flies may be attracted to a main body that is movable in an orbital-to-spin method and then be suctioned and captured by a vacuum negative pressure. Also, a shock generation part that generates an electrical shock due to current when the fly exterminating apparatus contacts flies while moving may be provided to exterminate the flies.

The fly exterminating apparatus according to the present invention includes a main body 100 on which a caterpillar 200 that orbitally rotates and wheels 210 are disposed on a lower portion thereof to move in an orbital-to-spin method, an attracting unit mounted on the main body 100 to attract flies, and a capture unit connected to the attracting unit to suction the flies attracted by the attracting unit by using a vacuum negative pressure.

In more detail, the main body 100 has a frame shape. Also, the rotatable wheels 210 are respectively disposed on both lower portions of the main body 100, and the caterpillar 200 that orbitally rotates is associated and connected to each of the wheels 210.

The caterpillar 200 may be disposed on each of both left and right sides of the main body 100 and orbitally rotate by driving force of a driving motor 250.

The attracting unit includes an attraction part 440 having a hopper shape with a diameter gradually increasing toward an upper portion thereof and a light emitting body 445 disposed on an inner surface of an inlet side of the attracting part 440 to emit light for attracting flies by applying an external power source.

The attracting part 440 has a hollow that has a diameter gradually decreasing toward a lower portion thereof.

The light emitting body 445 may adopt a general LED lighting. Thus, the light emitting body 445 may emit light having a color for attracting flies by applying an external power source.

Also, in the attracting unit, a well-known attracting agent in addition to the light emitting body 445 may be applied to an inner surface of the attracting part 440 to attract flies.

The capture unit includes a suction hose 420 having an end connected to a lower end of the attracting part 440, a capture container 410 connected to the other end of the suction hose 420 through a bottom thereof and having an opened upper portion, a cap member 430 openably coupled to an upper portion of the capture container 410 and having a plurality of punched suction holes 435 in an upper portion thereof, and a suction fan 500 connected to an upper portion of the cap member 430 to form a vacuum negative pressure within the capture container 410 through the suction hole 435. An unexplained reference number “422” may represent the other end of the suction hole 420 passing through the bottom of the capture container 410 and connected to the capture container 410.

That is, when the suction fan 500 is operated, the vacuum negative pressure is formed in inner spaces of the capture container 410 and the cap member 430. The vacuum negative pressure may be transmitted into the attracting part 440 through the suction hose 420 to suction flies.

The capture container 410 is formed of a metal material. A magnet member 432 is disposed on an outer circumferential surface of a lower portion of the cap member 430 to closely attach the lower portion of the cap member 430 to the capture container 410 by magnetic force of the magnet member 432. Here, when predetermined force or more is applied, the cap member 430 may be openable.

Also, a well-known shock generation part 900 that generates electrical shock by using current when the shock generation part 900 contacts flies is disposed on a front surface of the main body 100.

The shock generation part 900 through which the current flows is associated with the movement of the main body 100 to generate the electrical shock when the flies contact thereto.

Also, the shock generation part 900 further includes reflective plates 600 which are stacked and mounted on an upper portion of the main body 100 and have back surfaces that are capable of reflecting surrounding images and light and a reflective plate take-out part 650 for successively discharging the reflective plates 600 one by one to the outside when the main body 100 moves.

The reflective plates may adopt well-known CDs. When the reflective plates that are the CDs each having the back surface on which flies are projected are spread, the surrounding images (color and movement) projected on the back surface of each of the reflective plates 600 discombobulate eyes of the flies to make away with the files.

The reflective plate take-out part 650 includes a support plate 610 on which the reflective plates 600 are seated and stacked, the support plate 610 being disposed on a top surface of the main body 100 to elastically support the reflective plates 600 by using a spring member 620 as a medium and a solenoid 655 spaced from the support plate 610 and having a rod 652 for discharging the uppermost reflective plate 600 to the outside.

Here, the solenoid 655 may be a well-known solenoid. Also, the solenoid 655 may be replaced with an actuator such as a cylinder.

Also, a tank 700 in which an insecticide is filled and an spray nozzle 710 disposed on a front surface of the tank 700 to spray the insecticide filled within the tank 700 may be disposed on a front surface of the main body 100.

The spray nozzle 710 may include a valve type spray nozzle that is periodically opened to spray the insecticide filled within the tank 700. Alternatively, the spray nozzle 710 may be opened or closed by being associated with the movement of the main body 100.

The spray nozzle 710, the solenoid 655, and the driving motor 250 may be controlled in operation by a circuit board (a control part 800) mounted on the main body 100.

Effects of the present invention including the above-described parts will be described as follows.

In the fly exterminating apparatus according to the present invention, the main body 100 may move in an orbital-to-spin method by the wheels 210 and the caterpillar 200 so that the fly exterminating apparatus is used in outdoor and indoor spaces.

While the main body 100 moves, the shock generation part 900 disposed on the front surface of the main body 100 may generate electrical spark and shock when flies contact the shock generation part 900 to exterminate the flies.

Since the attracting part 440 that is an attracting unit has the hopper shape with the diameter gradually increasing toward the upper portion thereof, the attracting part 400 may easily attract flies therein by emitting light through the light emitting body 445 at night.

As described above, the flies attracted by the attracting unit may be suctioned into the capture container 410 by a vacuum suction force which is generated in side of the attracting part 440 through the suction hose 420 that is formed within the cap member 430 and the capture container 410 while air within the cap member 430 and the capture container 410 is discharged to the outside through the suction hole 435 when the suction fan 500 is operated.

That is, when flies approach the inside of the attracting part 440, the flies are suctioned into the capture container 410 through the suction hose 420 by the suction force generated by the suction fan 500 and then captured into an inner space of the capture container sealed by the cap member 430.

Thereafter, the cap member 430 may be opened to spray the insecticide toward the captured flies, thereby exterminate the flies.

As described above, since the plurality of magnet members 432 are disposed on the lower circumferential portion of the cap member 430, the cap member 430 may be maintained in a sealed state by the magnetic force with respect to the capture container 410 formed of the metal material or opened by lifting the cap member 430 due to force exceeding the magnetic force of the magnet member 432.

Also, the fly exterminating apparatus may spray the insecticide by using the tank 700 and the spray nozzle 710 which are disposed on the front surface of the main body 100 while moving by being associated with the movement of the main body 100.

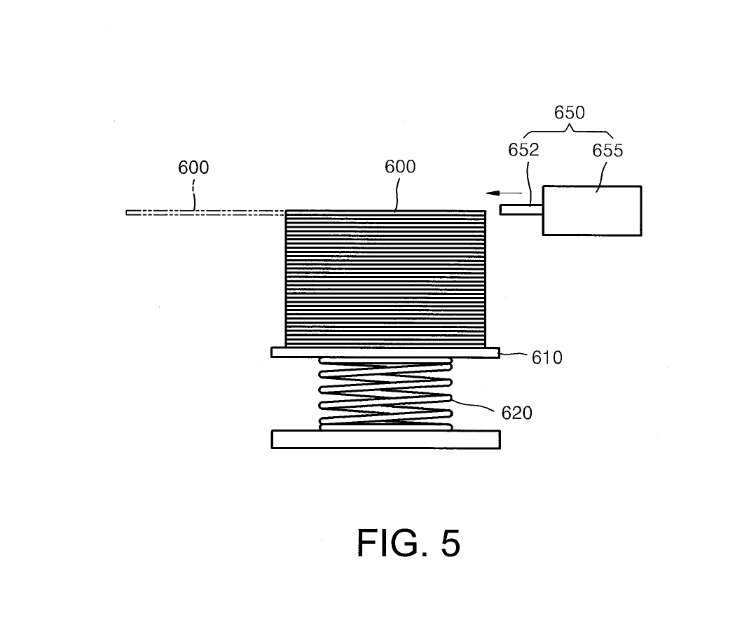

The reflective plate take-out part 650 may withdraw the rod 652 to successively discharge the reflective plates 600, which are stacked, seated, and elastically supported on the support plate 610, one by one. In this case, the reflective plates may be spread one by one on places at which flies are frequently appeared to discombobulate eyes of the flies by projecting the surrounding images (light and surrounding movements) or shapes of the flies, thereby making away with the flies (see FIG. 5).

In this case, even though the uppermost reflective plate 600 is withdrawn, since the next uppermost reflective plate 600 may be elastically supported on the support plate 610 by the elastic force of the spring member 620 and thus maintained in a horizontal state with respect to the rod 652.

The reflective plate take-out part 650 may be associated with the movement of the movable main body 100 to withdraw the reflective plates at desired places.

Thus, the fly exterminating apparatus according to the present invention may attract flies and then capture the flies through the vacuum negative pressure without applying chemicals such as fly attracting agents to exterminate flies without contaminating hygienic conditions. In addition, the fly exterminating apparatus may exterminate flies through various methods (by using the reflective plates 600 and the shock generation part 900).

First, since the main body is movable by the caterpillar and the wheels, the fly exterminating apparatus may be applied in the outdoor and indoor spaces to attract and capture flies without applying the chemicals such as the attracting agents.

Second, since the fly exterminating apparatus moves by being associated with the moving main body to exterminate flies through the shock generation part when contacting the flies, the user's convenience may be improved.

Third, since the reflective plates for discombobulating eyes of flies may be spread one by one on places at which the flies are frequently appeared to easily exterminate the flies.

Although the fly exterminating apparatus has been described with reference to the specific embodiments, it is not limited thereto. Therefore, it will be readily understood by those skilled in the art that various modifications and changes can be made thereto without departing from the spirit and scope of the present invention defined by the appended claims.

What is claimed is:

1. A fly exterminating apparatus comprising:
a main body (100) movable by a caterpillar (200) that orbitally rotates;
an attracting unit mounted on the main body (100) to attract flies; and
a capture unit connected to the attracting unit to suction the flies attracted by the attracting unit through a vacuum negative pressure, thereby capturing the flies,
wherein the fly exterminating apparatus further comprises:
reflective plates (600) stacked and mounted on an upper portion of the main body (100), the reflective plates (600) each having a back surface by which surrounding images and light are reflected; and
a reflective plate take-out part (650) for discharging the reflective plates (600) one by one to the outside when the main body (100) moves.

2. The fly exterminating apparatus of claim 1, wherein the attracting unit comprises:
an attracting part (440) having a hopper shape with a diameter gradually increasing toward an upper portion thereof; and
a light emitting body (445) disposed on an inner circumferential surface of an inlet side of the attracting part (440) to emit light for attracting the flies by applying an external power source thereto.

3. The fly exterminating apparatus of claim 1, wherein the capture unit comprises:
a suction hose (420) having one end connected to the attracting unit;
a capture container (410) to which the other end of the suction hose (420) is connected, the capture container (410) having an opened upper portion;
a cap member (430) openably coupled to the upper portion of the capture container (410), the cap member (430) having a plurality of punched suction holes (435) in an upper portion thereof; and
a suction fan (500) connected to the upper portion of the cap member (430) to form the vacuum negative pressure within the capture container (410) through the suction holes (435).

4. The fly exterminating apparatus of claim 1, further comprising a shock generation part (900), through which current flows to generate electrical shock when the shock generation part (900) contacts the flies, on a front surface of the main body (100).
